(19) United States
(12) Patent Application Publication
(10) Pub. No.: US 2018/0096214 A1
(43) Pub. Date: Apr. 5, 2018

(54) TAGGING APPARATUS, TAGGING SYSTEM, TAGGING METHOD, DIGEST CREATION APPARATUS, AND DIGEST CREATION SYSTEM

(71) Applicant: JVC Kenwood Corporation, Yokohama-shi (JP)

(72) Inventors: Mizuki Ohara, Yokohama-shi (JP); Jiro Uzaki, Yokohama-shi (JP); Kenji Matsuoka, Yokohama-shi (JP); Hideaki Onoda, Yokohama-shi (JP)

(73) Assignee: JVC Kenwood Corporation

(21) Appl. No.: 15/831,842

(22) Filed: Dec. 5, 2017

Related U.S. Application Data
(63) Continuation of application No. PCT/JP2016/001889, filed on Apr. 4, 2016.

(30) Foreign Application Priority Data
Jun. 12, 2015 (JP) 2015118858
Jun. 12, 2015 (JP) 2015118859

(51) Int. Cl. G06K 9/20; G06F 17/30

(52) U.S. Cl. CPC G06K 9/2054; G06F 17/30784; G06T 2207/10016; G06F 17/30247

(57) ABSTRACT

A tagging apparatus includes an image pickup unit configured to shoot a subject and output moving image data, a data communication unit configured to successively receive vital data of a user who records or plays back the moving image data, and receive timing data of a tag input by the user, and a tag range processing unit configured to set a time range tm to tn in which the vital data received by the data communication unit is equal to or greater than a predetermined value as a tag range tm to tn when a time corresponding to the timing data is included in the time range tm to tn.

### CROSS REFERENCE TO RELATED APPLICATION

This application is based upon and claims the benefit of priorities from Japanese patent applications No. 2015-118858 and No. 2015-118859, both of which were filed on Jun. 12, 2015 and the disclosures of both of which are incorporated herein in their entirety by reference.

### BACKGROUND

The present disclosure relates to a tagging apparatus, a tagging system, a tagging method, a digest creation apparatus, and a digest creation system.

Tagging frames in moving image data and then editing the moving image data later have been practiced. Further, recording only tagged frames in moving image data has also been practiced. For example, Japanese Unexamined Patent Application Publication No. 2014-192755 discloses that only frames for which flags F1 are set based on biological information, i.e., only frames which have been tagged based on biological information are recorded in a recording unit in an image recording apparatus.

Further, creating a digest video image from moving image data has been practiced. For example, Japanese Unexamined Patent Application Publication No. 2005-191770 discloses that a highlight scene moving image is cut out from a video image taken by a camera and an important scene is extracted from the moving image as a highlight still image in a highlight still image generation/distribution apparatus.

### SUMMARY

In the image recording apparatus according to the background art, although it is possible to clarify importance of moving image data by tagging, the number of tagged frames is fixed. Therefore, in some cases, some of important frames are left out.

As a tagging method, there is a method in which a user presses a button or the like to attach a tag during recording or viewing. However, in such a method, it is impossible to specify a range of an important scene, i.e., to specify from where to where an important scene is.

Further, it is possible to extract an important scene by the highlight still image generation/distribution apparatus according to the background art. However, in this apparatus, a part that is extracted as a highlight in a moving image during shooting is specified by using a sensor signal or specified manually. Therefore, it is not always possible to accurately extract a range important to a user from moving image data.

Therefore, in an embodiment, a tagging apparatus includes: an image pickup unit configured to shoot a subject and output moving image data; a data communication unit configured to successively receive vital data of a user who records or plays back the moving image data, and receive timing data of a tag input by the user; and a tag range processing unit configured to set a time range in which the vital data received by the data communication unit is equal to or greater than a predetermined value as a tag range when a time corresponding to the timing data is included in the time range.

Further, in an embodiment, a tagging method includes: a data communication step of successively receiving vital data of a user who records or plays back the moving image data, and receiving timing data of a tag input by the user; and a tag range processing step of setting a time range in which the vital data received in the data communication step is equal to or greater than a predetermined value as a tag range when a time corresponding to the timing data is included in the time range.

Further, in an embodiment, a digest creation apparatus includes: a data communication unit configured to successively receive vital data of a user who records or plays back the moving image data, and receive timing data of a tag input by the user; a tag range processing unit configured to set a time range in which the vital data received by the data communication unit is equal to or greater than a predetermined value as a tag range when a time corresponding to the timing data is included in the time range; and a digest processing unit configured to create a digest video image of the moving image data based on the tag range set by the tag range processing unit, in which when there are a plurality of tag ranges, the digest processing unit selects the tag range for creating the digest video image from the plurality of tag ranges based on a level of importance of the vital data in the tag range.

### BRIEF DESCRIPTION OF THE DRAWINGS

FIG. 1 is a block diagram showing a rough configuration of a digest creation system 1 according to an embodiment;

FIG. 2 shows a relation between changes in a heart rate over time and tag ranges that are set by using vital data (a heart rate) and tag data entered by a user according to an embodiment;

FIG. 3 shows a detailed relation between changes in a heart rate over time and tag ranges according to an embodiment;

FIG. 4 is a flowchart showing a detailed procedure of processes performed by a tag range processing unit 50 according to an embodiment;

FIG. 5 is a flowchart showing a procedure of processes performed by a digest processing unit 52 according to an embodiment;

FIG. 6 is a diagram for explaining processes performed by the digest processing unit 52 according to an embodiment;

FIG. 7 is a diagram for explaining processes performed by the digest processing unit 52 according to an embodiment; and

FIG. 8 is a diagram for explaining digest video image data according to an embodiment.

### DETAILED DESCRIPTION

A digest creation system according to an embodiment is explained hereinafter with reference to the drawings.

A digest creation system according to this embodiment accurately sets, when a user is shooting a sports game or the like, a tag range in an important range of shot data by using vital data (biological information) of the user and timing data of a tag that is entered in an important scene by the user and creates a digest video image.

Firstly, a configuration of the digest creation system according to this embodiment is explained.

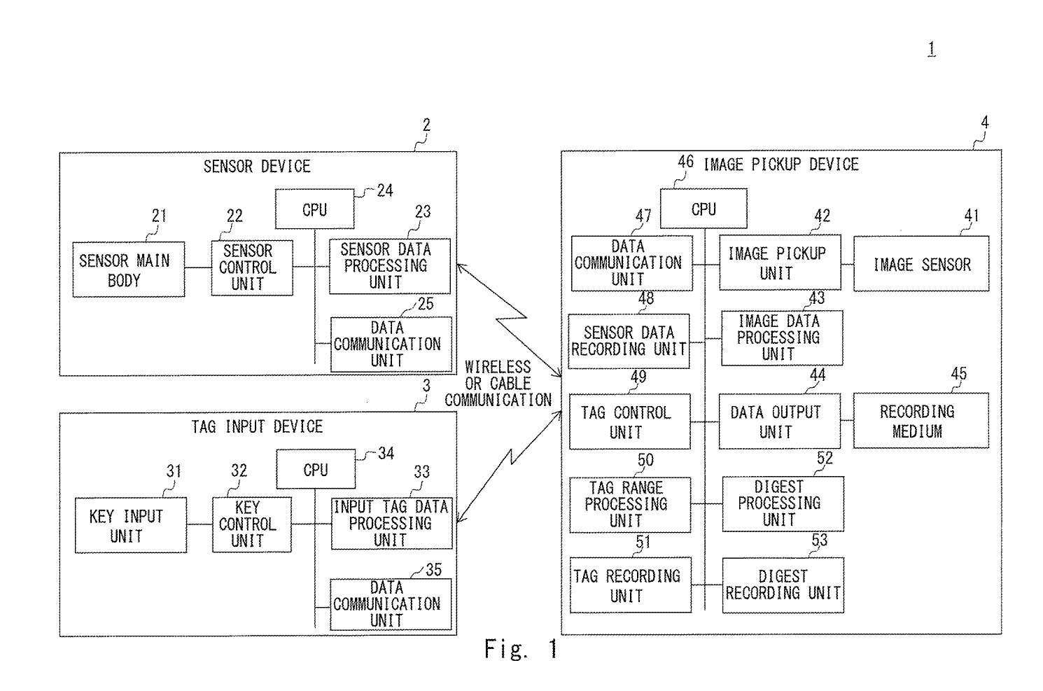

FIG. 1 is a block diagram showing a rough configuration of a digest creation system 1 according to this embodiment.

The digest creation system (or a tagging system) 1 includes a sensor device 2, a tag input device 3, an image pickup device 4, and so on. The sensor device 2 can communicate with the image pickup device 4 wirelessly or through a cable, and the tag input device 3 can communicate with the image pickup device 4 wirelessly or through a cable.

The sensor device 2 measures a heart rate, i.e., vital data of a user (not shown) when the user is shooting by using the image pickup device 4. The sensor device 2 includes, in addition to a configuration that an ordinary sensor device includes, such as a sensor main body 21, a sensor control unit 22, a sensor data processing unit 23, and a CPU 24, a data communication unit 25 that transmits the measured heart rate to the image pickup device 4 in real time.

The tag input device 3 is a device by which a user enters a tag by pressing a button or the like when the user wants to attach a tag in shot data while he/she is shooting by using the image pickup device 4, such as at the moment at which a goal is made in the case of a soccer game. The tag input device 3 includes, in addition to a configuration that an ordinary tag input device includes, such as a key input unit 31 such as a button or a screen, a key control unit 32, an input tag data processing unit 33, and a CPU 34, a data communication unit 35 that transmits input tag data, i.e., tag data entered by a user to the image pickup device 4 in real time.

The image pickup device (a digest creation apparatus or a tagging apparatus) 4 is a device capable of taking a moving image such as a video camera and a digital camera. The image pickup device 4 includes, in addition to a configuration that an ordinary image pickup device includes, such as an image sensor 41, an image pickup unit 42, an image data processing unit 43, a data output unit 44, a recording medium 45, and a CPU 46, a data communication unit 47, a sensor data recording unit 48, a tag control unit 49, a tag range processing unit 50, a tag recording unit 51, a digest processing unit 52, a digest recording unit 53, and so on.

The data communication unit 47 receives sensor data transmitted from the data communication unit 25 of the sensor device 2, input tag data transmitted from the data communication unit 35 of the tag input device 3, and so on. Further, the data communication unit 47 may transmit a signal for controlling an operation start timing and the like to the sensor device 2, the tag input device 3, and so on. That is, the data communication unit 25 of the sensor device 2 and the data communication unit 35 of the tag input device 3 may perform one-way or two-way communication, such as transmission/reception of a control signal, a status notification signal, and so on, with the data communication unit 47 of the image pickup device 4.

The sensor data recording unit 48 records sensor data received from the sensor device 2.

The tag control unit 49 controls an overall operation for attaching a tag (a tagging method) performed in the image pickup device 4.

The tag range processing unit 50 sets an appropriate range in moving image data taken by the image pickup device 4, for example, in the case where vital data is equal to or greater than a predetermined threshold at a timing at which a tag is recorded, a period in which the vital data is equal to or greater than the threshold, as a tag range by using the received sensor data and the input tag data. The tag range processing unit 50 can perform the above-described tag range setting during the shooting. Further, the tag range setting may be performed during the playback of the moving image.

The tag recording unit 51 records the received sensor data, the input tag data, and the set tag range in association with the moving image data during the shooting or during the playback of the moving image. Further, the tag recording unit 51 attaches a tag in the set tag range and records its timing data.

The input tag data includes, for example, a time at which the user entered the tag and a time at which the image pickup device 4 received the tag input. Instead of using the time, information on an elapsed time from some kind of synchronization timing such as a start of recording can be used as a substitute, provided that the sensor device 2, the tag input device 3, and the image pickup device 4 can recognize this common synchronization timing.

Note that when each of the sensor device 2, the tag input device 3, and the image pickup device 4 is equipped with a built-in clock, the sensor device 2 and the tag input device 3 do not need to transmit the measured heart rate and the input tag data to the image pickup device 4 in real time. It is possible to synchronize the timings of the moving image data, the vital data, and the input tag data based on their respective time information later. The received sensor data, the input tag data, the data on the set tag range, and the moving image data associated with them may also be recorded in the recoding medium 45.

The digest processing unit 52 creates a digest video image based on the tag range set by the tag range processing unit 50.

The digest recording unit 53 records data related to the digest video image created by the digest processing unit 52 in association with the moving image data.

Note that each component of the image pickup device 4 can be implemented by executing a program under control of the CPU 46. More specifically, the image pickup device 4 implements each component by loading a program stored in a storage unit (not shown) into a main storage device (not shown) and executing the loaded program under control of the CPU 46. Further, the implementation of each component is not limited to implementation by software using a program. That is, it may be implemented by hardware, firmware, software, or any combination thereof

The above-described program can be stored and provided to the image pickup device 4 using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.).

Further, the program may be provided to the image pickup device 4 using any type of transitory computer readable media. Examples of transitory computer readable media include electric signals, optical signals, and electromagnetic waves. Transitory computer readable media can provide the program to the image pickup device 4 via a wired communication line (e.g. electric wires, and optical fibers) or a wireless communication line.

Next, an operation of the digest creation system 1 according to this embodiment, i.e., a digest creation method is explained. Firstly, an outline of a tag rage setting operation performed by the tag range processing unit 50 is explained. As described above, the tag range processing unit 50 sets a tag in an appropriate range of moving image data taken by the image pickup device 4 by using received sensor data and input tag data.

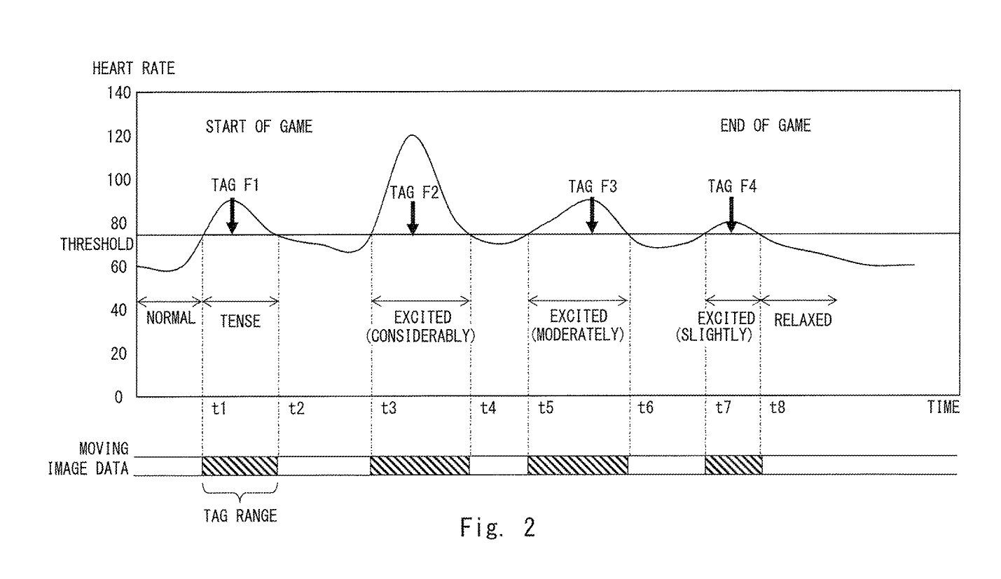

FIG. 2 shows a relation between changes in heart rates over time and tag ranges that are set by using vital data (heart rates) and tag data entered by a user according to this embodiment.

A graph of heart rates and tags F (tags F1 to F4 in this embodiment), i.e., input tag data are shown in an upper part. Further, ranges of the tags F (tag ranges) that are set based on the input tag data and associated with moving image data are shown in a lower part. In the graph of the heart rate, a horizontal axis indicates time and a vertical axis indicates heart rates. Further, a horizontal line near a heart rate of 75 indicates a threshold for setting tag ranges of tags F. Further, horizontal arrows and words such as “normal” and “tense” near a heart rate of 40 are for explaining a state of a user at that moment.

In the example shown in FIG. 2, the state of the user changes from a normal state to a tense state or an excited state, and to a normal (relaxed) state based on changes in the heart rate from a start of a game to an end thereof. Four peaks (1 to 4) occur in the heart rate in the tense state or the excited state, and the user enters tags F1 to F4 in these peaks, respectively.

The tag range processing unit 50 sets, when the user enters a tag Fin a time range in which the heart rate is equal to or greater than a predetermined value (a threshold of 75 in this example), that time range as a tag range of the tag F entered by the user. A tag may be attached to a frame corresponding to the time range.

For example, regarding the first peak, since the heart rate exceeds the predetermined value in a time range t1 to t2 and the user enters a tag F1, the time range t1 to t2 is set as a tag range of the tag F1. Further, regarding the second peak, since the heart rate exceeds the predetermined value in a time range t3 to t4 and the user enters a tag F2, the time range t3 to t4 is set as a tag range of the tag F2. The above explanation also applies to the third and fourth peaks.

Then, the tag range processing unit 50 records the tags F, and the tag ranges of these tags F and their time ranges (tag times) as a recorded tag list in the tag recording unit 51.

Note that even if there is a time range in which the heart rate is equal to or greater than the predetermined value, the tag range processing unit 50 does not set that time range as a tag range unless the user enters a tag F in that time range.

Further, even if the user enters a tag F, the tag range processing unit 50 sets a tag range according to a default setting or according to time and the number of frames set by a user when the heart rate is less than the predetermined value.

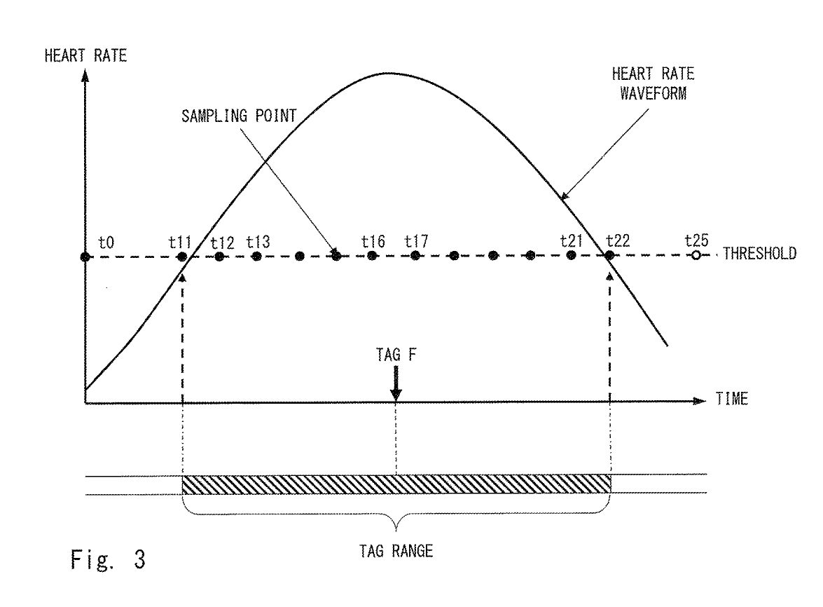

Next, a detailed procedure of processes performed by the tag range processing unit 50 is explained. FIG. 3 shows a detailed relation between changes in heart rates over time and tag ranges according to this embodiment. The heart rates are shown in an upper part of the graph and the tag ranges are shown in a lower part. A horizontal dotted line in the graph indicates a threshold and large dots arranged at regular intervals on the horizontal dotted line indicate sampling points of the heart rate, i.e., sampling timings. Note that the heart rate is sampled at, for example, intervals of one second.

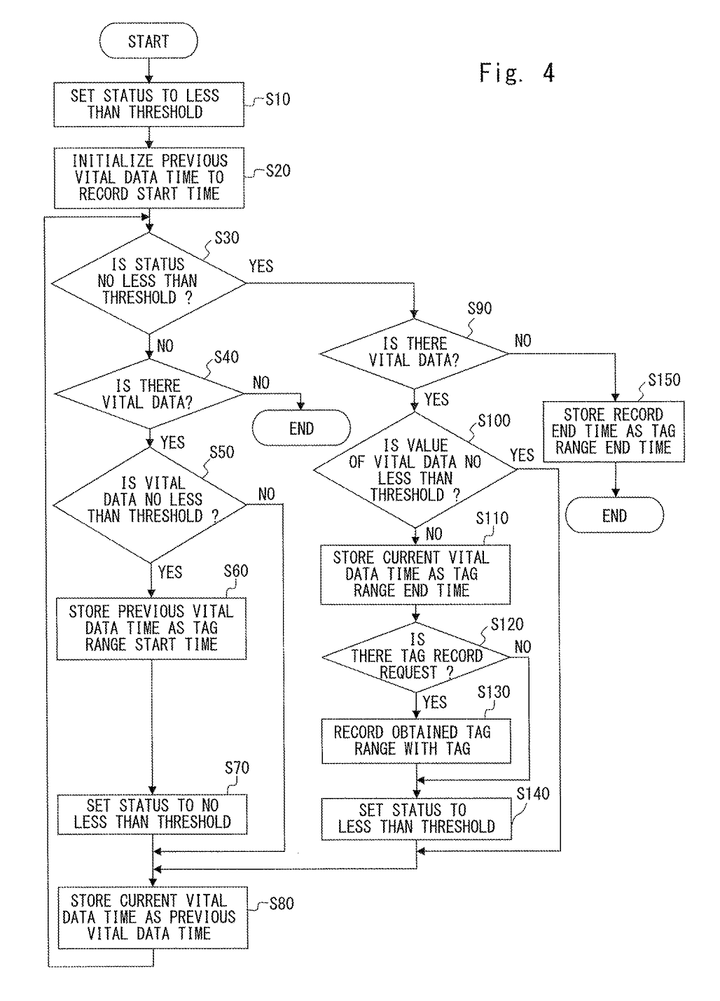

FIG. 4 is a flowchart showing a detailed procedure of processes performed by the tag range processing unit 50 according to this embodiment.

The detailed procedure of processes performed by the tag range processing unit 50 is explained with reference to FIGS. 3 and 4.

Firstly, when the process is started, the tag range processing unit 50 first sets a status indicating a state of vital data to “less than threshold” (step S10) and initializes “previous vital data time value” to a record start time t0 (step S20).

At the sampling time t0, the tag range processing unit 50 determines whether the status is “equal to or greater than threshold” (step S30). At the time to, since the status has not been changed from “less than threshold” set in the step S10 (No at step S30), the tag range processing unit 50 determines whether there is vital data that is received at the time to (step S40).

Since there is received vital data at the time t0 (Yes at step S40), the tag range processing unit 50 determines whether the value of the vital data at the time t0 is equal to or greater than the threshold (step S50). As shown in FIG. 3, since the value of the vital data at the time t0 is less than the threshold (No at step S50), the tag range processing unit 50 stores the current vital data time t0 as “previous vital data time value” (step S80). Then, the process returns to the step S30. Since the status remains as the normal state, i.e., the vital data is less than the threshold until a time tll, similar processes are repeated.

At a sampling time t12, since the status is “less than threshold” and there is vital data obtained at the time t12 (No at step S30 and Yes at step S40), the tag range processing unit 50 determines whether the value of the vital data at the time t12 is equal to or greater than the threshold (step S50). As shown in FIG. 3, since the value of the vital data at the time t12 is equal to or greater than the threshold (Yes at step S50), the tag range processing unit 50 stores “previous vital data time value”, i.e., the time t11 stored in the step S80 at this point as “tag range start time value” (step S60), sets the status to “equal to or greater than threshold” (step S70), stores the current vital data time t12 as “previous vital data time value” (step S80), and returns to the step S30.

Next, at a sampling time t13, since the status is “equal to or greater than threshold” as set in the step S70 (Yes at step S30), the tag range processing unit 50 determines whether there is vital data obtained at the time t13 (step S90).

Since there is vital data obtained at the time t13 (Yes at step S90), the tag range processing unit 50 determines whether the value of the vital data at the time t13 is equal to or greater than the threshold (step S100). As shown in FIG. 3, since the value of the vital data at the time t13 is equal to or greater than the threshold (Yes at step S100), the tag range processing unit 50 stores the current vital data time t13 as “previous vital data time value” (step S80) and returns to the step S30.

Then, processes similar to the process at the time t13 are continued until a sampling time t21.

Next, at a sampling time t22, since the status is “equal to or greater than threshold” and there is vital data received at the time t22 (Yes at step S30 and Yes at step S90), the tag range processing unit 50 determines whether the value of the vital data at the time t22 is equal to or greater than the threshold (step S100). As shown in FIG. 3, since the value of the vital data at the time t22 is less than the threshold (No at step S100), the tag range processing unit 50 stores the current vital data time t22 as “tag range end time value” (step S110) and determines whether there is a tag record request, i.e., determines whether a tag has been entered when the vital data value is equal to or greater than the threshold (step S120). As shown in FIG. 3, since the user has entered a tag F between the time t16 and t17 (Yes at step S120), the tag range processing unit 50 records the tag F with a tag range between the “tag range start time value” tll and the “tag range end time value” t22 obtained in the steps S60 and S110, respectively (step S130), sets the status to “less than threshold” (step S140), stores the current vital data time t22 as “previous vital data time value” (step S80), and returns to the step S30.

Next, at a sampling time t25, since the status is “less than threshold” and there is no vital data obtained at the time t25 (No at step S30 and No at step S40), the tag range processing unit 50 finishes the process.

Note that when the tag range processing unit 50 stores the current vital data time t as “tag range end time value” (step S110) and there is no tag record request, i.e., the user has not entered a tag (No at step S120), the tag range processing unit 50 sets the status to “less than threshold” (step S140). That is, as described above, even if there is a time range in which the heart rate is equal to or greater than the predetermined value, the tag range processing unit 50 does not set that time range as a tag range when the user has not entered a tag in that time range.

Further, when the status is “equal to or greater than threshold” and there is no vital data obtained at that time t (Yes at step S30 and No at step S90), the tag range processing unit 50 stores a record end time as “tag range end time value” (step S150). Further, similarly to the steps S120 and S130, when there is a tag record request, the tag range processing unit 50 records a tag F with an obtained tag range and finishes the process. Further, when there is no tag record request, the tag range processing unit 50 finishes the process as it is.

In this way, the tag range processing unit 50 can accurately set a tag range in an important range in moving image data.

Next, an operation performed by the digest processing unit 52 is explained.

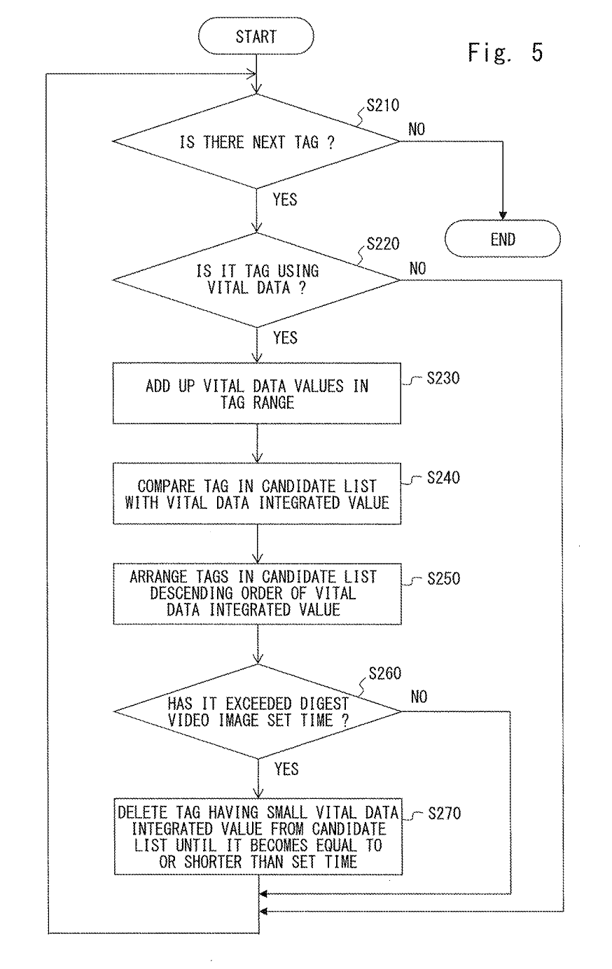

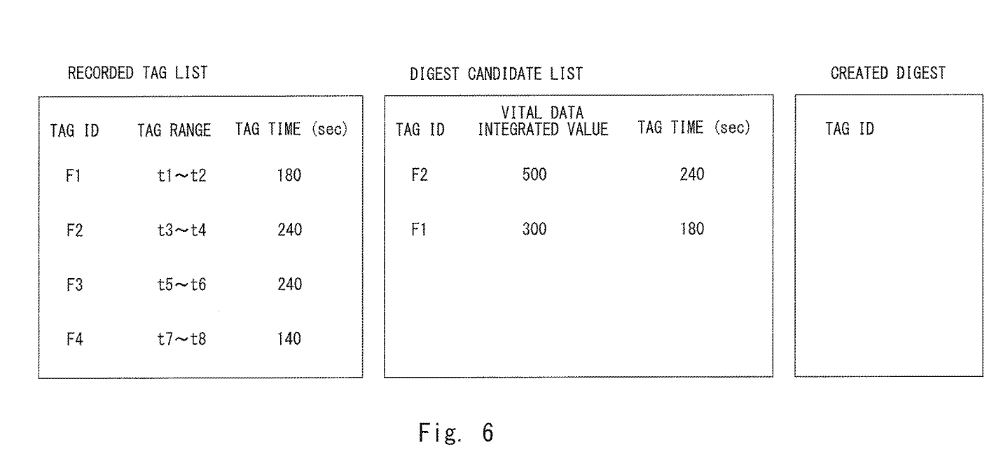

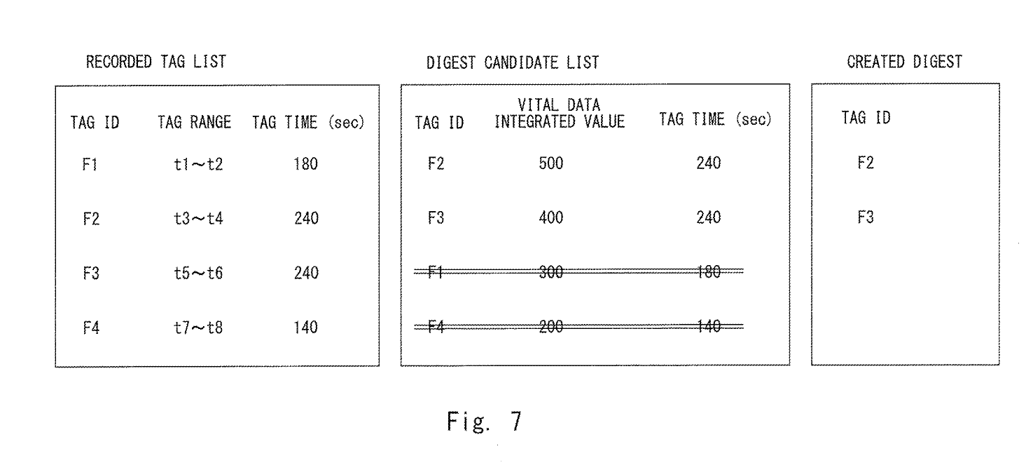

FIG. 5 is a flowchart showing a procedure of processes performed by the digest processing unit 52 according to this embodiment. FIGS. 6 and 7 are diagrams for explaining processes performed by the digest processing unit 52 according to this embodiment.

Each of FIGS. 6 and 7 shows, from its left side, a recorded tag list, a digest candidate list, and a created digest.

As described above, the recorded tag list is created by the tag range processing unit 50 and recorded in the tag recording unit 51. Further, the recorded tag list includes information such as tag IDs, tag start times, and tag times set by the tag range processing unit 50. The digest candidate list is created by the digest processing unit 52 and recorded in a storage unit included in the digest processing unit 52 or in the digest recording unit 53. Further, the digest candidate list includes information such as tag IDs of tags that are possibly used in digest video images, vital data integrated values for respective tags, and tag times for respective tags.

The created digest is created by the digest processing unit 52 and recorded in the digest recording unit 53. Further, the created digest includes information on tag IDs of tags used in digest video images.

Note that FIG. 6 shows a state after processes for tags F1 and F2 have been finished in a procedure of processes explained below. FIG. 7 shows a state after the process is finished in the aforementioned procedure of processes.

Further, the recorded tag list, the digest candidate list, and the created digest can also be stored in the recoding medium 45 together with moving image data.

The procedure of processes performed by the digest processing unit 52 is explained with reference to FIGS. 5 to 7. It is assumed that the digest processing unit 52 creates a digest video image whose length is 10 minutes or shorter by referring to a setting of a digest video image set time. In the digest video image set time, a user sets a length of a digest video image that the user wants to create in advance.

Firstly, when the process is started, the digest processing unit 52 first determines whether there is a tag F that should be added in the recorded tag list (step S210). The digest processing unit 52 refers to the recorded tag list in an orderly manner from the top of the list and determines that there is a tag F1 (Yes at step S210).

Then, the digest processing unit 52 determines whether the tag F is a tag that is set by using vital data and tag data entered by a user (step S220). The digest processing unit 52 determines that the tag F1 is a tag using the vital data and the tag data entered by the user (Yes at step S220).

Then, the digest processing unit 52 adds up (i.e., integrates) vital data values in a tag range (step S230). In this example, the digest processing unit 52 adds up heart rates in a time range t1 to t2, i.e., in the tag range of the tag F1 and thereby calculates an integrated value of 300. The integrated vale of the vital data becomes an index indicating a level of importance of the tag F.

Then, the digest processing unit 52 compares a tag ID in the candidate list with the vital data integrated value (step S240). In the case of the tag F1, since no other tag F is recorded in the candidate list, the process proceeds to the next step.

Then, the digest processing unit 52 arranges tags F corresponding to tag IDs in the candidate list in descending order of their vital data integrated values (step S250). In the case of the tag F1, since no other tag ID is recorded in the candidate list, the digest processing unit 52 records the tag F1 and proceeds to the next step.

Then, the digest processing unit 52 determines whether the length of the created digest video image has exceeded the digest video image set time (step S260). The tag time of the tag F1 is three minutes (180 seconds). Therefore, the digest processing unit 52 determines that the length of the created digest video image has not exceeded the digest video image set time, which is 10 minutes as described above (No at step S260) and returns to the step S210.

Next, similarly, the digest processing unit 52 determines that there is a tag F2 (Yes at step S210), determines that the tag F2 is a tag using vital data (Yes at step S220), and calculates an integrated value of 500 of heart rates in a time range t3 to t4, i.e., the tag range of the tag F2 (step S230).

Then, the digest processing unit 52 compares the tag F1 in the candidate list with the vital data integrated value (step S240) and arranges tags IDs in the candidate list in descending order of their vital data integrated values (step S250). In this example, the integrated value of the tag F1 is 300 and the integrated value of the tag F2 is 500. Therefore, the digest processing unit 52 arranges the tags F1 and F2 so that the tag F2 is listed above the tag F1.

Further, the tag time of the tag F2 is four minutes (240 seconds) and the tag time of the tag F1 is three minutes. Therefore, since the tag time is seven minutes in total, the digest processing unit 52 determines that the length of the created digest video image has not exceeded the digest video image set time, which is 10 minutes (No at step S260). As described above, FIG. 6 shows a state at this point, i.e., a state just after the processes for the tags F1 and F2 have been finished. Then, the process returns to the step S210.

Next, similarly, the digest processing unit 52 calculates an integrated value of 400 of heart rates in a time range t5 to t6, i.e., the tag range of the tag F3 (steps S210 to S230).

Then, the digest processing unit 52 compares the tags F2 and F1 in the candidate list with the vital data integrated value (step 5240) and arranges tags F in the candidate list in descending order of their vital data integrated values, i.e., in the order of the tags F2, F3 and F1 (step S250).

Further, the tag time of the tag F3 is four minutes (240 seconds) and the tag times of the tags F2 and F1 are four minutes and three minutes, respectively. Therefore, since the tag time is 11 minutes in total, the digest processing unit 52 determines that the length of the created digest video image has exceeded the digest video image set time, which is 10 minutes (Yes at step S260).

Then, the digest processing unit 52 deletes a tag ID having a small vital data integrated value from the candidate list one by one until the length of the created digest video image is equal to or shorter than the set time (step S270). In this example, firstly, the tag F1 having a small vital data integrated value is deleted. As a result, the sum total of the tag times of the tags F2 and F3 becomes eight minutes and hence is shorter than the set time, the process returns to the step S210,

Next, similarly, the digest processing unit 52 calculates an integrated value of 140 of heart rates in a time range t7 to t8, i.e., the tag range of the tag F4 (steps S210 to S230), and arranges tag IDs in the candidate list in descending order of their vital data integrated values, i.e., in the order of the tags F2, F3 and F4 (steps S240 and S250).

Further, the tag time of the tag F4 is two minutes and 20 seconds (140 seconds) and the total tag time of the tags F2, F3 and F4 becomes 10 minutes and 20 seconds. Therefore, the digest processing unit 52 determines that the length of the created digest video image has exceeded the digest video image set time. Therefore, digest processing unit 52 makes the total tag time equal to or shorter than the set time by deleting the tag F4 having a small vital data integrated value (steps S260 and S270) and returns to the step S210.

Then, when the digest processing unit 52 determines that there is no tag F (No at step S210), it records tag IDs of the tags F remaining in the digest candidate list in the created digest and finishes the process. FIG. 7 shows a state at this point, i.e., a state just after the process has been finished. The tags F2 and F3 remaining in the digest candidate list are recorded in the created digest as they are. Note that in FIG. 5, the deleted tags F1 and F4 are also shown with strikethrough (double lines) for a reference purpose.

Further, when the digest processing unit 52 determines that a tag F is not a tag using vital data (No at step S220), it returns to the step S10.

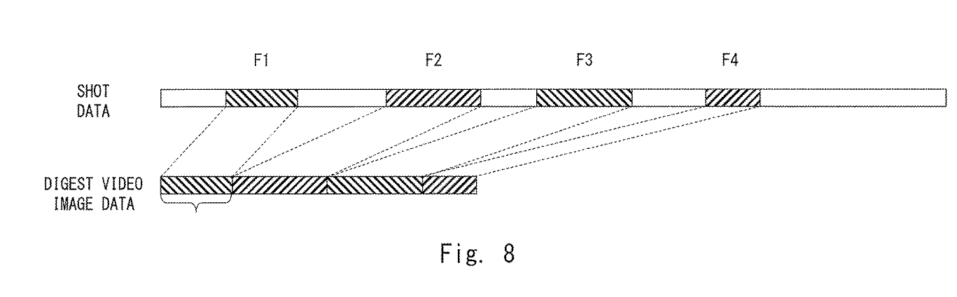

FIG. 8 is a diagram for explaining digest video image data according to this embodiment. Shot data is shown in an upper part and digest video image data is shown in a lower part. In this example, the digest video image set time is infinite.

In the digest video image data, the lengths of the tag times of the tags F1 to F4 differ from one another. This means that digest video images are created by accurately extracting ranges important to the user.

As described above, the digest creation system 1 according to this embodiment can create a digest video image by accurately extracting a range important to a user from moving image data. Further, the level of importance is also determined for the extracted range and hence a digest video image within a set time can be created.

Note that in the digest creation system 1 according to this embodiment, the tag range processing unit 50 selects a time t11 to a time t22 as a time range in which the heart rate exceeds the threshold and sets this time range as a tag range. However, the tag range processing unit 50 may select a time t12 to a time t21 corresponding to a sampling time that is one timing inside the time t11 to t22 at either end as a time range and set this time range as a tag range. Needless to say, it is possible to select the time t11 to t21 or the time t12 to t22 as a time range. Further, it is possible to select a range between two points at each of which the heart rate crosses the threshold as a time range. In such a case, points at which the heart rate crosses the threshold may be calculated and/or the number of times of sampling of a moving image and the number of times of sampling of vital data may be made equal to each other.

Further, in the digest creation system 1 according to this embodiment, the threshold for the heart rate by which the tag range processing unit 50 sets a tag range is fixed. However, the threshold may be set according to a situation, e.g., may be set for each user or for each scene. Further, the threshold may be changed at any time so that a tag range can be adjusted even after moving image data is recorded.

Further, in the digest creation system 1 according to this embodiment, the tag range processing unit 50 sets a time range in which the heart rate is equal to or greater than the predetermined value as a tag range when a user enters a tag in that time range. However, the tag range processing unit 50 may set, when a user enters a tag in a time range in which the heart rate is equal to or greater than the predetermined value, a time range that starts a predetermined time before the tag input and ends the predetermined time after the tag input, e.g., a time range that start three seconds before the tag input and ends three seconds after the tag input, as a tag range. Needless to say, the system may be configured so that a user can select either a time range in which the heart rate is equal to or greater than a predetermined value or a time range that starts a predetermined time before a tag and ends the predetermined time after the tag.

Further, although the heart rate is used as the vital data in the digest creation system 1 according to this embodiment, data other than the heart rate, e.g., data indicating a level of excitement of a user may be used as the vital data. In such a case, when a user enters a tag F in a time range in which the vital data is no greater than a predetermined value or is less than a predetermined value, that time range may be set as a tag range of the tag F.

Further, in the digest creation system 1 according to this embodiment, the digest processing unit 52 determines the level of importance of a tag F by using an integrated value of heart rates (vital data). However, the level of the importance of a tag F may be determined by using an integrated value of heart rates above a threshold, i.e., an integrated value of “values obtained by subtracting a threshold from each heart rate”. Further, the level of importance of a tag F may be determined by using a value other than the integrated value of vital data, such as a magnitude of an absolute value of a peak of vital data, a sharpness (a magnitude of a changing rate) of a peak of vital data, the number of tags F per unit time (a tag density), or a length of a tag range (a length of a tag time).

Further, in the digest creation system 1 according to this embodiment, the threshold of the heart rate by which a tag range of a tag F is set is fixed. However, the threshold may be set according to a situation, e.g., may be set for each user or for each scene. Further, the threshold may be changed at any time so that a tag range of a tag F can be adjusted even after moving image data is recorded.

Further, the digest creation system 1 according to this embodiment includes the sensor device the tag input device 3, the image pickup device 4, and so on. However, the digest creation system 1 may have a configuration in which an image pickup device also serves as both a sensor device and a tag input device, or a configuration in which an image pickup device also serves as one of a sensor device and a tag input device. That is, the digest creation system may be configured as a digest creation apparatus or a tagging apparatus.

Further, the digest creation system 1 according to this embodiment creates a digest video image by setting a tag range based on vital data of a user and input tag data that are obtained when the user is shooting by using the image pickup device 4, i.e., when the user is recording moving image data. However, the digest creation system 1 may create a digest video image by setting a tag range based on vital data of a user and input tag data that are obtained when the user is viewing or editing moving image data by using an image processing apparatus or the like, i.e., when the user is playing back moving image data. That is, the digest creation apparatus according to this embodiment is not limited to be the image pickup apparatus but may also be an image processing apparatus and the like.

As described above, a tagging apparatus 4 according to this embodiment includes an image pickup unit 42 configured to shoot a subject and output moving image data, a data communication unit 47 configured to successively receive vital data of a user who records or plays back the moving image data, and receive timing data of a tag input by the user, and a tag range processing unit 50 configured to set a time range tm to tn in which the vital data received by the data communication unit 47 is equal to or greater than a predetermined value as a tag range tm to tn when a time corresponding to the timing data is included in the time range tm to tn.

Further, the tagging apparatus 4 according to this embodiment includes a tag recording unit 51 configured to attach a tag in a tag range and record the attached tag data.

Further, a tagging system 1 according to this embodiment includes a sensor device 2 configured to measure the vital data of the user and output the measured vital data to the data communication unit 47, a tag input device 3 configured to output the timing data to the data communication unit 47, and the tagging apparatus 4.

Further, a digest creation apparatus 4 according to this embodiment includes a data communication unit 47 configured to successively receive vital data of a user who records or plays back the moving image data, and receive timing data of a tag input by the user, a tag range processing unit 50 configured to set a time range tm to tn in which the vital data received by the data communication unit 47 is equal to or greater than a predetermined value as a tag range tm to tn when a time corresponding to the timing data is included in the time range tm to tn, and a digest processing unit 52 configured to create a digest video image of the moving image data based on the tag range set by the tag range processing unit 50, in which when there are a plurality of tag ranges, the digest processing unit 52 selects the tag range for creating the digest video image from the plurality of tag ranges based on a level of importance of the vital data in the tag range.

Further, the digest creation apparatus 4 according to this embodiment calculates a level of importance of the vital data in the digest processing unit 52 by adding up vital data values in the tag range.

Further, a digest creation system 1 according to this embodiment includes a sensor device 2 configured to measure the vital data of the user and output the measured vital data to the data communication unit 47, a tag input device 3 configured to output the timing data of the tag input by the user to the data communication unit 47, and the digest creation apparatus 4.

A digest creation system 1 according to this embodiment accurately sets a tag range in an important range in shot data by using vital data of a user and timing data of a tag entered by the user and creates a digest video image. Therefore, the digest creation system 1 is industrially applicable.

What is claimed is:

1. A tagging apparatus comprising:
an image pickup unit configured to shoot a subject and output moving image data;
a data communication unit configured to successively receive vital data of a user who records or plays back the moving image data, and receive timing data of a tag input by the user; and
a tag range processing unit configured to set a time range in which the vital data received by the data communication unit is equal to or greater than a predetermined value as a tag range when a time corresponding to the timing data is included in the time range.

2. The tagging apparatus according to claim 1, further comprising a recording unit configured to attach a tag in the tag range and record the attached tag data.

3. A tagging system comprising:
a sensor device configured to measure the vital data of the user and output the measured vital data to the data communication unit;
a tag input device configured to output the timing data to the data communication unit; and
a tagging apparatus according to claim 1.

4. A tagging method comprising:
a data communication step of successively receiving vital data of a user who records or plays back the moving image data, and receiving timing data of a tag input by the user; and
a tag range processing step of setting a time range in which the vital data received in the data communication step is equal to or greater than a predetermined value as a tag range when a time corresponding to the timing data is included in the time range.

5. A digest creation apparatus comprising:
a data communication unit configured to successively receive vital data of a user who records or plays back the moving image data, and receive timing data of a tag input by the user;
a tag range processing unit configured to set a time range in which the vital data received by the data communication unit is equal to or greater than a predetermined value as a tag range when a time corresponding to the timing data is included in the time range; and
a digest processing unit configured to create a digest video image of the moving image data based on the tag range set by the tag range processing unit, wherein
when there are a plurality of tag ranges, the digest processing unit selects the tag range for creating the digest video image from the plurality of tag ranges based on a level of importance of the vital data in the tag range.

6. The digest creation apparatus according to claim 5, wherein a level of importance of the vital data in the digest processing unit is calculated by adding up vital data values in the tag range.

7. A digest creation system comprising:
a sensor device configured to measure the vital data of the user and output the measured vital data to the data communication unit;
a tag input device configured to output the timing data of the tag input by the user to the data communication unit: and
a digest creation apparatus according to claim 5.
